(19) United States
(12) Patent Application Publication
(10) Pub. No.: US 2026/0022763 A1
(43) Pub. Date: Jan. 22, 2026

(54) VEHICLE ELECTRICAL CONTROL APPARATUS WITH MANUAL GEAR SWITCHING FUNCTION

(71) Applicant: JEN-CHIH LIU, Kaohsiung City (TW)

(72) Inventor: JEN-CHIH LIU, Kaohsiung City (TW)

(21) Appl. No.: 18/773,611

(22) Filed: Jul. 16, 2024

(51) Int. Cl. F16H 59/02; F16H 59/08

(52) U.S. Cl. CPC F16H 59/0204; F16H 59/08; F16H 2059/0221; F16H 2059/081

(57) ABSTRACT

A vehicle electrical control apparatus with a manual gear switching function includes a camshaft assembly. An electrical control device is connected to a driving shaft of the camshaft assembly for performing an electrical gear switching on the driving shaft. A manual gear switching device is connected to the driving shaft for performing a manual gear switching on the driving shaft. A first locating groove is formed on the driving shaft to be used for performing the electrical gear switching. An outer gear is arranged on the driving shaft and is located on an upper side of the locating groove for being engaged to a manual knob of the manual gear switching device. A second locating groove is formed on the driving shaft and is located on an upper side of the outer gear to be used for performing the manual gear switching.

### FIELD OF THE INVENTION

The present invention is related to apparatus of an electrical control apparatus for a vehicle, and in particular to a vehicle electrical control apparatus with a manual gear switching function.

### BACKGROUND OF THE INVENTION

Referring to the prior arts shown in FIGS. 1 and 2, in the prior arts, a gear shifting box A1 of a vehicle includes a gear switching device which has a driving power unit A2 and a camshaft assembly A3 for gear switching. Due to the continuous technological advancement and evolution, the power source of the vehicle is gradually changing to the electric structure. Therefore, the gear switching mechanism of the vehicle has also changed from the traditional manually operated gear switching to the electrical gear switching. Related developments of the driving power unit A2 and camshaft assembly A3 are continuously performed due to evolution and breakthroughs of technology. In the driving power unit A2, an electrical control box A21 has been developed to receive the external input power for activing the motor to generate rotating power to drive a driving shaft A31 of the camshaft assembly A3 for rotating a gear switching cam.

However, in the actual operation, the failures and other unforeseen conditions of the electrical power will cause that it is impossible to switch the gears due to power outages. Many developers are pursuing breakthroughs and innovations to improve above shortcomings, but many existing technical solutions are still limited by the concepts of traditional technology, resulting in complex structure, high cost, complicated processing, high failure rate, heavy weight and maintenance difficulties. Therefore, there is a real need to further improve these prior arts to effectively increase the practical inventive step and industrial utilization of the patented technology creation.

### SUMMARY OF THE INVENTION

Accordingly, the object of the present invention is to provide a vehicle electrical control apparatus with a manual gear switching function, wherein when the vehicle electrical control apparatus is unable to input the electrical power for performing the gear switching due to a power interruption or a failure of the electronic control components, the manual gear switching device can be pulled and moved upwards by a directly manual operation of the user for performing an accurate gear switching and an automatic positioning of every gear switching operation at any time. Therefore, the present invention can effectively achieve the advantages of safety, solid structure, industrial utilization and high economic efficiency.

To achieve above object, the present invention provides a vehicle electrical control apparatus with a manual gear switching function, comprising: a camshaft assembly including a driving shaft; an electrical control device connected to a gear switching end of the driving shaft; the electrical control device including a gear assembly installed on the driving shaft; the electrical control device serving to input an electrical gear switching power to drive the driving shaft for performing an electrical gear switching on the driving shaft; a manual gear switching device connected to the gear switching end of the driving shaft; the manual gear switching device serving to input a manual gear switching power to drive the driving shaft for performing a manual gear switching on the driving shaft; a first locating groove formed on the gear switching end of the driving shaft to be used for the electrical gear switching of the electrical control device; an outer gear arranged on the driving shaft and located on an upper side of the locating groove for being engaged to a manual knob of the manual gear switching device; a second locating groove formed on the driving shaft and located on an upper side of the outer gear to be used for the manual gear switching of the manual gear switching device; wherein in an electrical gear switching state, the manual gear switching device is connected to the first locating groove to be connected to the gear assembly; the gear assembly is driven by the electrical gear switching power of the electrical control device which is inputted by a motor to drive the gear shaft for performing the electrical gear switching; when the gear assembly is driven to be rotated, the manual gear switching device is driven by the gear assembly; and wherein when the electrical gear switching state is switched to a manual gear switching state, a manual knob of the manual gear switching device is driven to be moved upwards and is connected to the second locating groove to be separated from the gear assembly; and the gear shaft is driven by the manual gear switching power from the manual gear switching device to drive the gear assembly for performing the manual gear switching.

### BRIEF DESCRIPTION OF THE DRAWINGS

FIG. 1 is a schematic view of the prior art.

FIG. 2 is an assembled schematic view of the prior art.

FIG. 3 is a schematic view showing the electrical gear switching state of the embodiment of the present invention.

FIG. 4 is a schematic view showing the manual gear switching state of the embodiment of the present invention.

FIG. 5 is a schematic view showing the electrical control box of the present invention.

FIG. 6 is a top view of the electrical control box in FIG. 5.

FIG. 7 is a schematic view showing the assembling of the electrical control box of the present invention.

FIG. 8 is a schematic view showing the assembling of the motor seat, the gear assembly, the driving shaft and the finger assembly of the present invention.

FIG. 9 is a schematic view of the gear assembly of the present invention.

FIG. 10 is a schematic view showing the bottom side of the gear assembly of the present invention.

FIG. 11 is a schematic view showing another side of the gear assembly of the present invention.

FIG. 12 is a left side view of the gear assembly in FIG. 11.

FIG. 13 is a right side view of the gear assembly in FIG. 11.

FIG. 14 is an assembled schematic view of the main components of the electrical control device and the manual gear switching device of the present invention.

FIG. 15 is a schematic view of the driving shaft of the present invention.

FIG. 16 is a schematic view of the manual knob of the present invention.

FIG. 17 is an assembled schematic view of the manual knob and the gear assembly of the present invention.

FIG. 18 is a schematic section view on the line A-A of FIG. 5, which shows that the manual knob is switched to a neutral (N) gear positon state.

FIG. 19 is a schematic section view on the line A-A of FIG. 5, which shows that the manual knob is switched to a reverse (R) gear positon state.

FIG. 20 is a schematic view of the finger assembly of the present invention.

FIG. 21 is a schematic view showing the bottom side of the finger assembly of the present invention.

FIG. 22 is a schematic view showing another side of the finger assembly of the present invention.

FIG. 23 is a left side view of the finger assembly in FIG. 22.

FIG. 24 is a right side view of the finger assembly in FIG. 22.

FIG. 25 is a schematic view showing the gear position connecting ring of the present invention.

FIG. 26 is a schematic view showing another side of the gear position connecting ring of the present invention.

FIG. 27 is a left side view of the gear position connecting ring in FIG. 26.

FIG. 28 is a right side view of the gear position connecting ring in FIG. 26.

FIG. 29 is a schematic view showing the operating of the electrical gear switching of the embodiment of the present invention.

FIG. 30 is a schematic view showing the operating of the manual gear switching of the embodiment of the present invention.

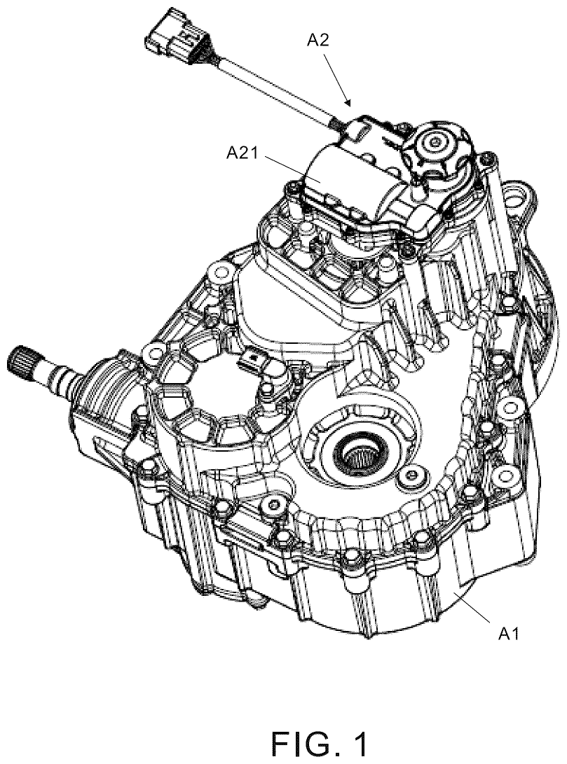

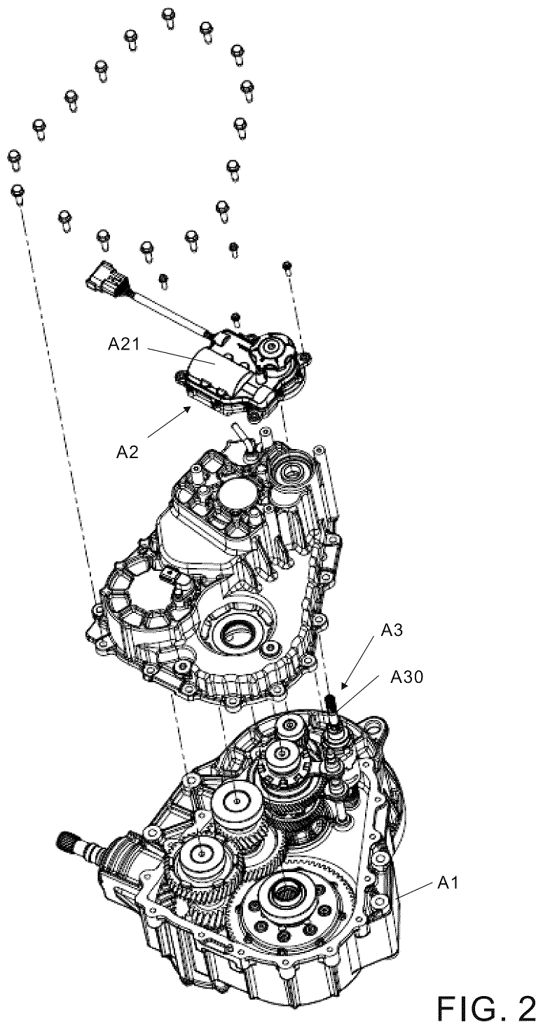

### DETAILED DESCRIPTION OF THE INVENTION

In order that those skilled in the art can further understand the present invention, a description will be provided in the following in details. However, these descriptions and the appended drawings are only used to cause those skilled in the art to understand the objects, features, and characteristics of the present invention, but not to be used to confine the scope and spirit of the present invention defined in the appended claims.

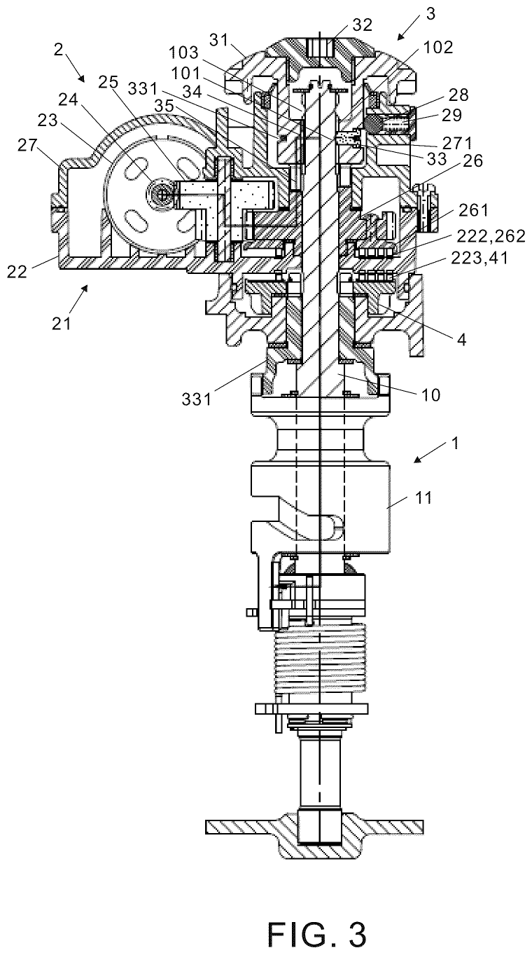

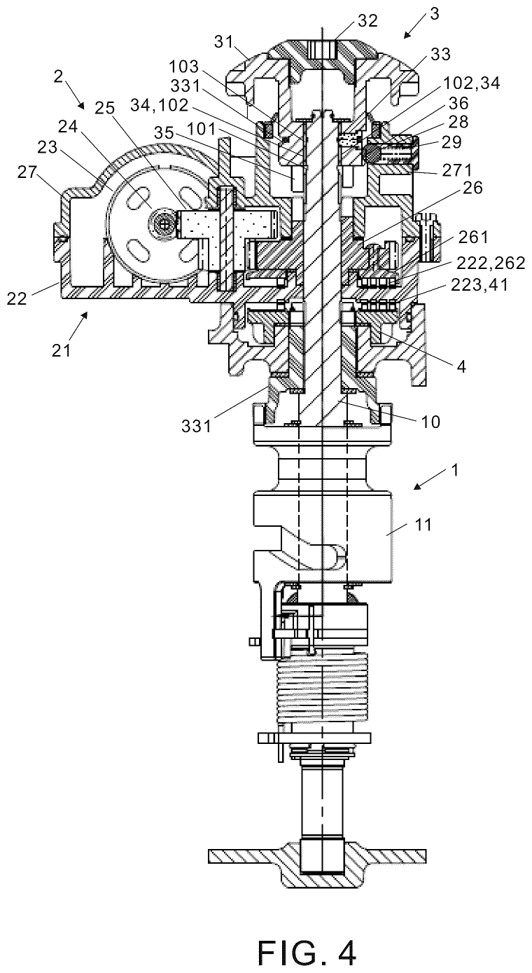

With reference to FIGS. 3 to 4, the structure of the present invention is illustrated. The present invention includes the following elements.

A camshaft assembly 1 includes a driving shaft 10.

An electrical control device 2 is connected to a gear switching end of the driving shaft 10. The electrical control device 2 includes a gear assembly 26 installed on the driving shaft 10. The electrical control device 2 serves to input an electrical gear switching power to drive the driving shaft 10 for performing an electrical gear switching on the driving shaft 10.

A manual gear switching device 3 is connected to the gear switching end of the driving shaft 10. The manual gear switching device 3 serves to input a manual gear switching power to drive the driving shaft 10 for performing a manual gear switching on the driving shaft 10.

When a control of the vehicle electrical control apparatus is switched from the electrical control device 2 to the manual gear switching device 3, the manual gear switching device 3 is separated from a motor power driving path of the electrical control device 2 to prevent an interference from the motor 23 (e.g. when the motor 23 has a deadlock failure). An electrical gear position and a cam gear position are detected and outputted to two electrical control units respectively (not shown in Figure) for being displayed to the user, which achieves the dual detection function of the electrical control apparatus of the present invention. The electrical gear position is a gear position of an electrical control system of the vehicle, and the cam gear position is a gear position of a cam gear 11 on the driving shaft 10 of the camshaft assembly 1 (the two gear positions are not synchronized in a buffering state). Therefore, the present invention achieves an advantage that, when the electrical gear switching is unable to be performed on the driving shaft 10 by the electrical control device 2 due to a power failure of the vehicle electrical control apparatus, the manual gear switching can be quickly and easily performed on the driving shaft 10 by the manual gear switching device 3 which can be manually controlled by the user of the vehicle.

Referring to FIGS. 3, 4 and 15, a first locating groove 101 is formed on the gear switching end of the driving shaft 10 to be used for the electrical gear switching of the electrical control device 2. The first locating groove 101 is a V-shaped groove. An outer gear 102 is arranged on the driving shaft 10 and is located on an upper side of the locating groove 101 for being engaged to a manual knob 31 of the manual gear switching device 3. A second locating groove 103 is formed on the driving shaft 10 and is located on an upper side of the outer gear 102 to be used for the manual gear switching of the manual gear switching device 3. The second locating groove 103 is a V-shaped groove.

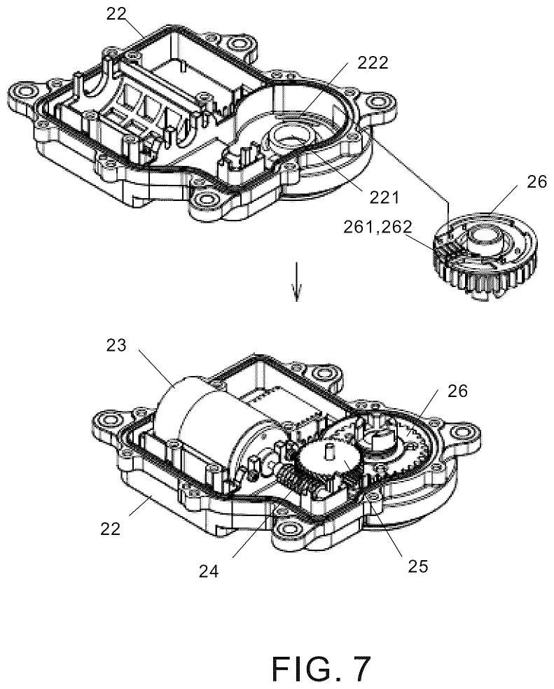

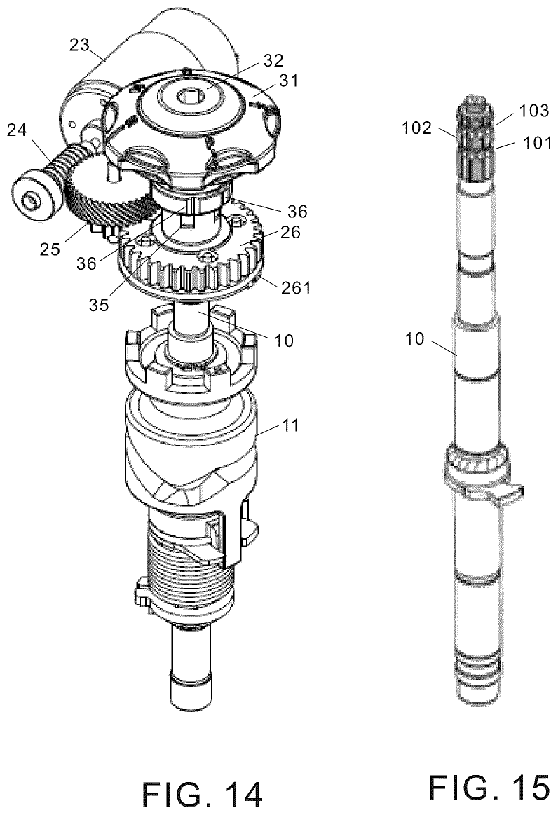

Referring to FIGS. 3, 4, 7 and 14, the electrical control device 2 includes an electrical control box 21 and a motor seat 22 located in the electrical control box 21. A motor 23, a worm screw 24, a double gear 25, and a gear assembly 26 are installed in the electrical control box 21. The gear assembly 26 in FIG. 7 is shown in an upside down manner. The gear assembly 26 is installed on the driving shaft 10. A lower side of the gear assembly 26 is connected to an upper gear position detecting unit 261 and an upper detecting finger 262. The motor seat 22 has a penetrating hole 221 for receiving the driving shaft 10. An upper detecting copper sheet 222 is installed on an upper side of the penetrating hole 221 for detecting the electrical gear position. A lower detecting copper sheet 223 is installed on a lower side of the penetrating hole 221 for detecting the cam gear position of the cam gear 11 which is installed on the driving shaft 10.

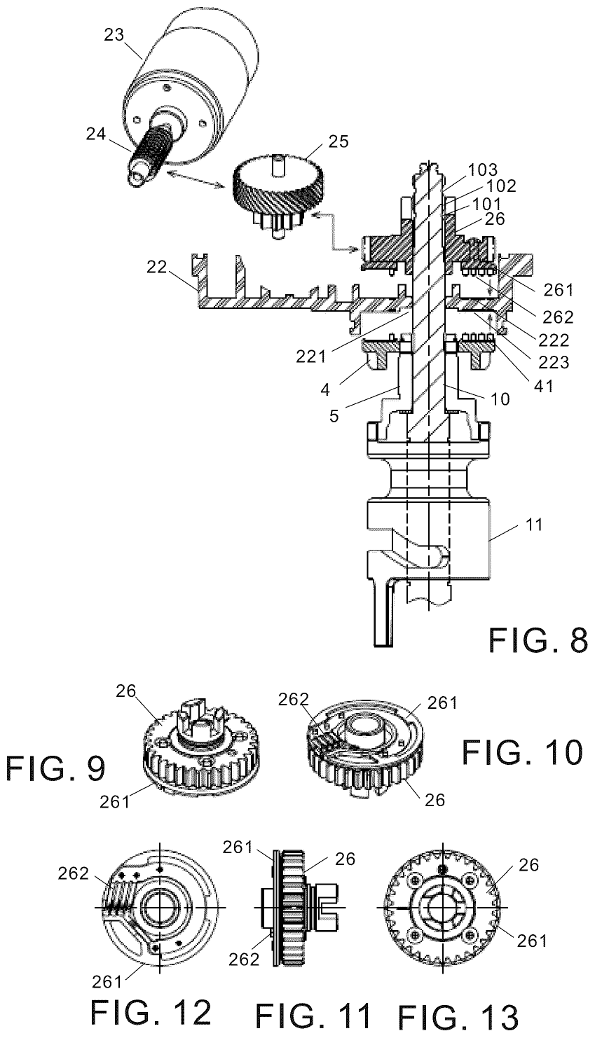

Referring to FIGS. 7, 8 and 20 to 24, a finger assembly 4 is arranged on the lower side of the penetrating hole 221 of the motor seat 22. A lower detecting finger 41 is installed on an upper side of the finger assembly 4. A lower side of the finger assembly 4 is connected to a gear position connecting ring 5 to be connected to the cam gear 11. Referring to FIGS. 7 and 8, the motor 23 is connected to the worm screw 24 which is connected to the double gear 25. The double gear 25 is connected to the gear assembly 26. The motor power driving path is formed by the connecting between the motor 23, the worm screw 24, the double gear 25 and the gear assembly 26. The gear assembly 26 is driven by motor 23 through the worm screw 24 and the double gear 25. When the gear assembly 26 is driven by the electrical control device 2 or the manual gear switching device 3, the upper gear position detecting unit 261 is driven by the gear assembly 26 for detecting the electrical gear position, and the finger assembly 4 is driven by the gear assembly 26 to drive the lower detecting finger 41 to detect the cam gear position of the cam gear 11. Detection signals from the upper gear position detecting unit 261 and the lower detecting finger 41 are outputted to the two electrical control units respectively for achieving the dual detection of the electrical control apparatus of the present invention. Therefore, the electrical gear position and the cam gear position can be displayed to the user.

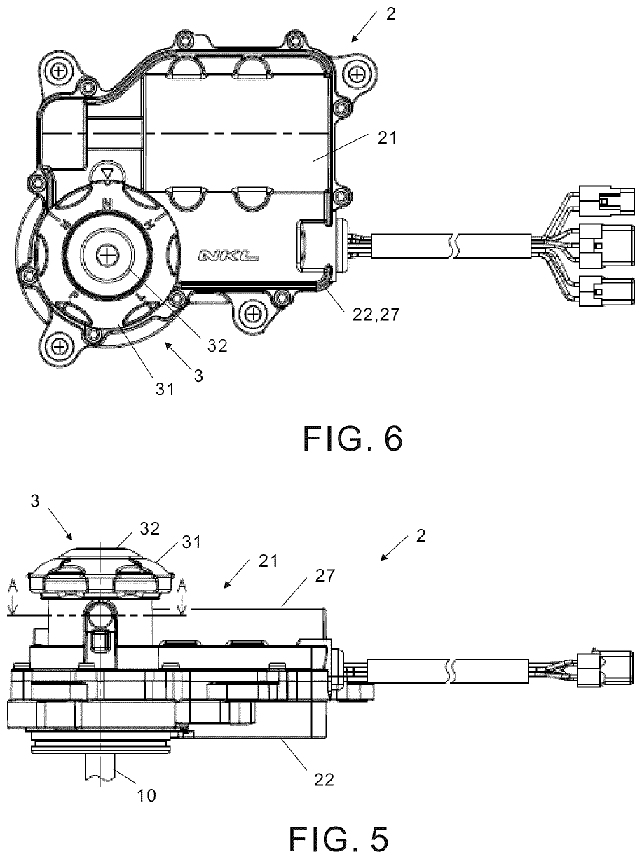

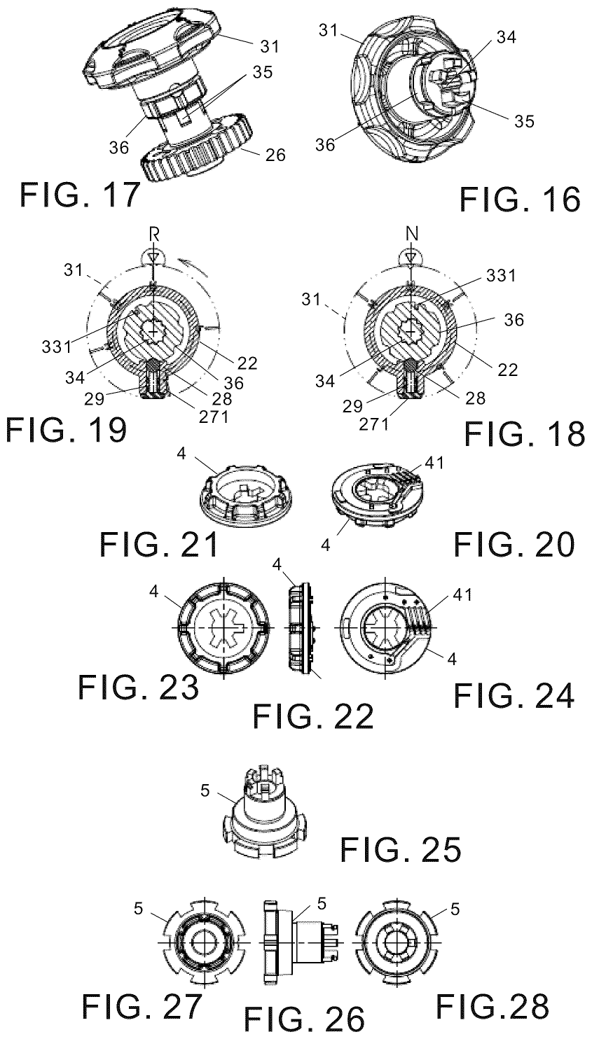

Referring to FIGS. 3 to 6, 8 and 14, the manual gear switching device 3 includes the manual knob 31 and a hex socket head cap screw 32 which are installed on an upper motor cover 27 of the electrical control box 21. A locating post 33 penetrates the manual knob 31 and serves to be positioned in the first locating groove 101 or the second locating groove 103. A locating buckle ring 331 is installed on the manual knob 31. A spring seat 271 is located in the upper motor cover 27 for receiving a steel ball 28 and a compressing spring 29. Referring to FIGS. 3, 4 and 16 to 19, a rear end of the steel ball 28 resists against the compressing spring 29. A front end of the steel ball 28 resists against an outer side of the manual knob 31. An inner gear 34 is formed on a lower inner side of the manual knob 31 and serves to be engaged and connected to the outer gear 102 of the driving shaft 10. At least one square slot 35 is formed in a lower bottom side of the manual knob 31 and is capable of being connected to or separated from the gear assembly 26. When the control of the vehicle electrical control apparatus is switched from the electrical control device 2 to the manual gear switching device 3, the manual gear switching device 3 will be separated from the power driving path of the electrical control device 2 for performing the manual gear switching, which avoids the interference from the motor 23.

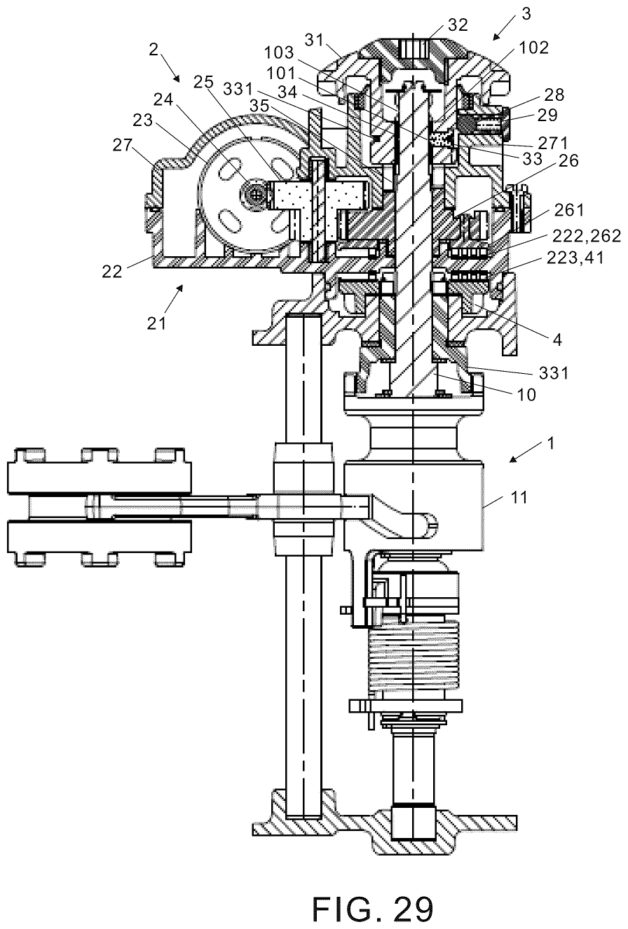

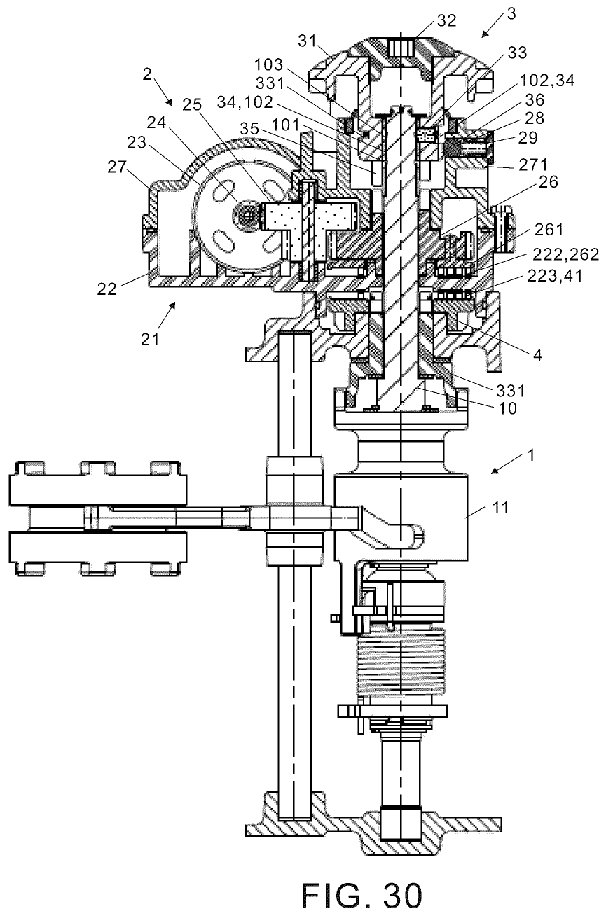

Referring to FIG. 29, in an electrical gear switching state, the manual gear switching device 3 is connected to the first locating groove 101 to be connected to the gear assembly 26. The gear assembly 26 is driven by the electrical gear switching power of the electrical control device 2 which is inputted by a motor 23 to drive the gear shaft 10 for performing the electrical gear switching. When the gear assembly 26 is driven to be rotated, the manual gear switching device 3 is driven by the gear assembly 26. In the electrical gear switching state, the gear assembly 26 is engaged to the at least one square slot 35. The inner gear 34 is engaged to the driving shaft 10. The locating post 33 is positioned at the first locating groove 101. The outer side of the manual knob 31 resists against the front end of the steel ball 28 to push the steel ball 28 into the spring seat 271 and compress the compressing spring 29. Therefore, the electrical gear switching power inputted by the motor 23 is transmitted through the motor power driving path to drive the driving shaft 10 for performing the electrical gear switching of the electrical control device 2.

Referring to FIG. 30, when the electrical gear switching state is switched to a manual gear switching state, a manual knob 31 of the manual gear switching device 3 is driven to be moved upwards and is connected to the second locating groove 103 to be separated from the gear assembly 26. The gear shaft 10 is driven by the manual gear switching power of the manual gear switching device 3 to drive the gear assembly 26 for performing the manual gear switching. In the manual gear switching state, the manual knob 31 is driven to be moved upwards to drive the at least one square slot 35 being moved upwards to be separated from the gear assembly 26. When the manual knob 31 is moved upwards, the inner gear 34 is moved to be engaged to the outer gear 102 of the driving shaft 10 and the locating post 33 is moved to be positioned at the second locating groove 103. The compressing spring 29 in the spring seat 271 extends to push the steel ball 28 and the front end of the steel ball 28 protrudes from the spring seat 271 to be engaged to a buckling ring 36 which surrounds a lower end of the outer side of the manual knob 31. Therefore, the manual gear switching of the manual gear switching device 3 can be performed on the driving shaft 10.

When the manual knob 31 is moved upwards, the locating post 33 is moved from the first locating groove 101 to the second locating groove 103 to cause that the manual knob 31 is separated from the gear assembly 26 and the inner gear 34 is engaged to the outer gear 102. Therefore, in the manual gear switching state, the manual gear switching device 3 can be controlled by a manual operating inputted from the user to input the manual gear switching power to directly drive the driving shaft 10 for performing the manual gear switching, which prevents the interference from the motor 23 (e.g. when the motor 23 has a deadlock failure). Moreover, the steel ball 28 is positioned at one of a plurality of locating positions on the buckling ring 36. A manual gear switching can be performed by that the steel ball 28 is switched to a different locating position of the buckling ring 36 by rotating of the manual knob 31. As a result, the manual gear switching can be performed accurately, easily and safely.

The advantages of the present invention are that, when the vehicle electrical control apparatus is unable to input the electrical power for performing the gear switching due to a power interruption or a failure of the electronic control components, the manual gear switching device can be pulled and moved upwards by a directly manual operation of the user for performing an accurate gear switching and an automatic positioning of every gear switching operation at any time. Therefore, the present invention can effectively achieve the advantages of safety, solid structure, industrial utilization and high economic efficiency.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A vehicle electrical control apparatus with a manual gear switching function, comprising:
a camshaft assembly (1) including a driving shaft (10);
an electrical control device (2) connected to a gear switching end of the driving shaft (10); the electrical control device (2) including a gear assembly (26) installed on the driving shaft (10); the electrical control device (2) serving to input an electrical gear switching power to drive the driving shaft (10) for performing an electrical gear switching on the driving shaft (10);
a manual gear switching device (3) connected to the gear switching end of the driving shaft (10); the manual gear switching device (3) serving to input a manual gear switching power to drive the driving shaft (10) for performing a manual gear switching on the driving shaft (10);
a first locating groove (101) formed on the gear switching end of the driving shaft (10) to be used for the electrical gear switching of the electrical control device (2); an outer gear (102) arranged on the driving shaft (10) and located on an upper side of the locating groove (101) for being engaged to a manual knob (31) of the manual gear switching device (3); a second locating groove (103) formed on the driving shaft (10) and located on an upper side of the outer gear (102) to be used for the manual gear switching of the manual gear switching device (3);
wherein in an electrical gear switching state, the manual gear switching device (3) is connected to the first locating groove (101) to be connected to the gear assembly (26); the gear assembly (26) is driven by the electrical gear switching power of the electrical control device (2) which is inputted by a motor (23) to drive the gear shaft (10) for performing the electrical gear switching; when the gear assembly (26) is driven to be rotated, the manual gear switching device (3) is driven by the gear assembly (26); and
wherein when the electrical gear switching state is switched to a manual gear switching state, a manual knob (31) of the manual gear switching device (3) is driven to be moved upwards and is connected to the second locating groove (103) to be separated from the gear assembly (26); and the gear shaft (10) is driven by the manual gear switching power from the manual gear switching device (3) to drive the gear assembly (26) for performing the manual gear switching.

2. The vehicle electrical control apparatus with the manual gear switching function as claimed in claim 1, wherein the electrical control device (2) includes an electrical control box (21) and a motor seat (22) located in the electrical control box (21); the motor (23), a worm screw (24), a double gear (25), and the gear assembly (26) are installed in the electrical control box (21); the gear assembly (26) is installed on the driving shaft (10); a lower side of the gear assembly (26) is connected to an upper gear position detecting unit (261) and an upper detecting finger (262); the motor seat (22) has a penetrating hole (221) for receiving the driving shaft (10); an upper detecting copper sheet (222) is installed on an upper side of the penetrating hole (221) for detecting an electrical gear position; and a lower detecting copper sheet (223) is installed on a lower side of the penetrating hole (221) for detecting a cam gear position of a cam gear (11) which is installed on the driving shaft (10).

3. The vehicle electrical control apparatus with the manual gear switching function as claimed in claim 2, wherein a finger assembly (4) is arranged on the lower side of the penetrating hole (221) of the motor seat (22); a lower detecting finger (41) is installed on an upper side of the finger assembly (4); a lower side of the finger assembly (4) is connected to a gear position connecting ring (5) to be connected to the cam gear (11); the motor (23) is connected to the worm screw (24) which is connected to the double gear (25); the double gear (25) is connected to the gear assembly (26); the gear assembly (26) is driven by motor (23) through the worm screw (24) and the double gear (25); when the gear assembly (26) is driven by the electrical control device (2) or the manual gear switching device (3), the upper gear position detecting unit (261) is driven by the gear assembly (26) for detecting the electrical gear position, and the finger assembly (4) is driven by the gear assembly (26) to drive the lower detecting finger (41) to detect the cam gear position of the cam gear (11).

4. The vehicle electrical control apparatus with the manual gear switching function as claimed in claim 1, wherein the manual gear switching device (3) includes the manual knob (31) and a hex socket head cap screw (32) which are installed on an upper motor cover (27) of the electrical control box (21); a locating post (33) penetrates the manual knob (31) and serves to be positioned in the first locating groove (101) or the second locating groove (103); a locating buckle ring (331) is installed on the manual knob (31); a spring seat (271) is located in the upper motor cover (27) for receiving a steel ball (28) and a compressing spring (29); a rear end of the steel ball (28) resists against the compressing spring (29); a front end of the steel ball (28) resists against an outer side of the manual knob (31); an inner gear (34) is formed on a lower inner side of the manual knob (31) and serves to be connected to the outer gear (102) of the driving shaft (10); and at least one square slot (35) is formed in a lower bottom side of the manual knob (31) and is capable of being connected to or separated from the gear assembly (26).

5. The vehicle electrical control apparatus with the manual gear switching function as claimed in claim 4, wherein in the electrical gear switching state, the gear assembly (26) is engaged to the at least one square slot (35); the inner gear (34) is engaged to the driving shaft (10); the locating post (33) is positioned at the first locating groove (101); the outer side of the manual knob (31) resists against the front end of the steel ball (28) to push the steel ball (28) into the spring seat (271) and compress the compressing spring (29).

6. The vehicle electrical control apparatus with the manual gear switching function as claimed in claim 4, wherein in the manual gear switching state, the manual knob (31) is driven to be moved upwards to drive the at least one square slot (35) being moved upwards to be separated from the gear assembly (26); when the manual knob (31) is moved upwards, the inner gear (34) is moved to be engaged to the outer gear (102) of the driving shaft (10) and the locating post (33) is moved to be positioned at the second locating groove (103); and the compressing spring (29) in the spring seat (271) extends to push the steel ball (28) and the front end of the steel ball (28) protrudes from the spring seat (271) to be engaged to a buckling ring (36) which surrounds a lower end of the outer side of the manual knob (31).

7. The vehicle electrical control apparatus with the manual gear switching function as claimed in claim 1, wherein an inner gear (34) is formed on a lower inner side of the manual knob (31) and serves to be engaged to the outer gear (102) of the driving shaft (10); a buckling ring (36) surrounds a lower end of the outer side of the manual knob (31) for positioning a steel ball (28); and at least one square slot (35) is formed in a lower bottom side of the manual knob (31) for being connected to or separated from the gear assembly (26).

8. The vehicle electrical control apparatus with the manual gear switching function as claimed in claim 1, wherein the first locating groove (101) is a V-shaped groove; and the second locating groove (103) is a V-shaped groove.
